(19) United States
(12) Patent Application Publication
(10) Pub. No.: US 2012/0227278 A1
(43) Pub. Date: Sep. 13, 2012

(54) EXCESS MOISTURE DRYING APPARATUS

(76) Inventor: THERESA TRENTACOSTA, Tinton Falls, NJ (US)

(21) Appl. No.: 13/417,912

(22) Filed: Mar. 12, 2012

Related U.S. Application Data
(60) Provisional application No. 61/451,194, filed on Mar. 10, 2011.

(51) Int. Cl. F26B 5/16; F26B 25/00

(52) U.S. Cl. 34/329; 34/95.1

(57) ABSTRACT

Embodiments of the present invention relate to an apparatus for use in tough to dry areas, such as the gasket of a front loading washing machine, to remove excess moisture built up in such areas, and prevent mold growth. In one embodiment, an excess moisture drying apparatus comprises a handle portion having a base and a protruding handle extending therefrom, and a sponge affixed to the handle portion via an attachment means, the sponge having an inner core having a substantially rigid or formable material, and an outer core comprising a chamois cloth or a woven fabric cloth, and the sponge having a gross water absorption property of at least 5.0%, defined as the volume of the weight of the liquid absorbed to the weight of the dry material, per volume, wherein the drying portion is sized to form fit within a water-sealing gasket of a front loading washing machine.

### CROSS-REFERENCE TO RELATED APPLICATIONS

The present application claims priority to U.S. Provisional Patent Application Ser. No. 61/451/194, entitled “Excess Moisture Drying Apparatus,” filed Mar. 10, 2011, the disclosure of which is incorporated herein by reference in its entirety.

### BACKGROUND

1. Field of the Invention

Embodiments of the present disclosure generally relate to an excess moisture drying apparatus. More specifically, embodiments of the present invention relate to an apparatus for use in tough to dry areas, such as the gasket of a front loading washing machine, that can remove excess moisture built up in such areas, and prevent mold growth.

2. Description of Related Art

Most owners of front loading washing machines generally complain about the same problem—that is, the build-up of excess moisture within the rubber gasket surrounding the door to the washing machine. The gasket is generally provided to prevent water and soap for escaping the washing machine during operation, but too often, it also acts as a catchall for small pools of water after the machine stops running. In addition to collection of water in the gasket, often water builds up in the soap compartment and other areas that are exposed to the interior portion of the washing machine during operation.

A simple attempt at solving this problem is to allow the washing machine to air dry after each use, by leaving the doors open and compartments open that accumulate water. While this may work in dry environments where the water may quickly evaporate, most washing machines are kept in basements or common areas of a residence, where temperature and humidity are regulated. Similarly, another solution involves using a hand towel or paper towel to wipe out the areas with the moisture. While this may work, reaching around the bends and corners of the gasket can be difficult with someone's hand, and such areas are the most common locations for water to accumulate.

As such, there is a need for excess moisture drying apparatus for use in tough to dry areas, such as the gasket of a front loading washing machine, that can remove excess moisture built up in such areas, and prevent mold growth.

### SUMMARY

Embodiments of the present disclosure generally relate to an excess moisture drying apparatus. More specifically, embodiments of the present invention relate to an apparatus for use in tough to dry areas, such as the gasket of a front loading washing machine, that can remove excess moisture built up in such areas, and prevent mold growth.

In one embodiment of the present invention, an excess moisture drying apparatus comprises a handle portion, and a drying portion affixed to the handle portion via an attachment means, wherein the drying portion is sized to form fit within a water-sealing gasket of a front loading washing machine.

In another embodiment of the present invention, an excess moisture drying apparatus comprises a handle portion having a base and a protruding handle extending therefrom, and a sponge affixed to the handle portion via an attachment means, the sponge having an inner core having a substantially rigid or formable material, and an outer core comprising a chamois cloth or a woven fabric cloth, and the sponge having a gross water absorption property of at least 5.0%, defined as the volume of the weight of the liquid absorbed to the weight of the dry material, per volume, wherein the drying portion is sized to form fit within a water-sealing gasket of a front loading washing machine.

In yet another embodiment of the present invention, a method of drying a water-sealing gasket of a front loading washing machine comprises providing a drying apparatus comprising: a handle portion having a base and a protruding handle extending therefrom; and a sponge affixed to the handle portion via an attachment means, the sponge having an inner core having a substantially rigid or formable material, and an outer core comprising a chamois cloth or a woven fabric cloth, and the sponge having a gross water absorption property of at least 5.0%, defined as the volume of the weight of the liquid absorbed to the weight of the dry material, per volume; wherein the drying portion is sized to form fit within the water-sealing gasket of a front loading washing machine; placing the drying apparatus within the gasket; and wiping the entire length of the gasket with the drying apparatus.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a perspective view of an excess moisture drying apparatus in accordance with one embodiment of the present invention;

FIG. 2 depicts a side view of an excess moisture drying apparatus in accordance with another embodiment of the present invention;

FIG. 3 depicts a plurality of alternative handles in accordance with further embodiments of the present invention; and

FIG. 4 depicts a plurality of alternative drying sponges in accordance with further embodiments of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the Figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to an excess moisture drying apparatus. More specifically, embodiments of the present invention relate to an apparatus for use in tough to dry areas, such as the gasket of a front loading washing machine, that can remove excess moisture built up in such areas, and prevent mold growth.

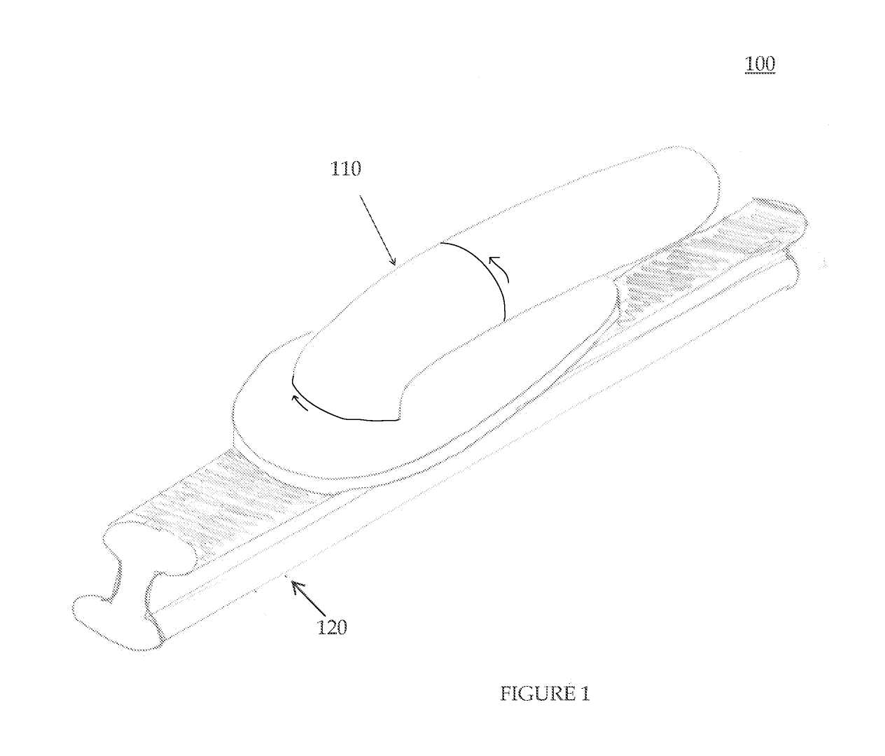

FIG. 1 depicts a perspective view of an excess moisture drying apparatus in accordance with one embodiment of the present invention. The excess moisture drying apparatus 100 shown in FIG. 1, generally comprises a handle 110 and a drying sponge 120. The excess moisture drying apparatus 100 may generally be any size suitable for embodiments of the present invention, solely limited by the intended application of a particular embodiment of the present invention.

In one embodiment, the handle 110 comprises a base portion and a protruding handle extending therefrom, as shown in the Figure. The handle 110 generally comprises any type of material suitable for embodiments of the present invention, capable of enabling a user to hold the excess moisture drying apparatus 100 during operation. In one embodiment, the handle 110 comprises a polymer, such as polyethylene terephthalate (PET), polyethylene (PE), high-density polyethylene, polyvinyl chloride (PVC), polyvinylidene chloride (PVDC) low-density polyethylene (LDPE), polypropylene (PP), Polystyrene (PS), high impact polystyrene (HIPS), polyamides (PA), acrylonitrile butadiene styrene (ABS), polycarbonate (PC), polycarbonate/acrylonitrile butadiene styrene (PC/ABS), polyurethanes (PU), or the like.

In alternative embodiments, the handle 110 comprises a wood material, optionally coated to prevent mold or deterioration due to its likelihood of moisture exposure. In other embodiments, the handle 110 may comprise a metal, such as carbon steel, stainless steel, aluminum, brass, copper, lead, magnesium, titanium, zinc, nickel, or the like. In further embodiments, the handle 110 may comprise a glass material, a ceramic material, or the like. Also, in other embodiments, the handle 110 may comprise a natural or synthetic rubber material.

Although shown in the Figure as extending in the same direction as the drying sponge 120, the handle 110 may often be provided at an angle, e.g., a right angle, to an axis of the drying sponge 120. In some embodiments, the handle 110 may optionally be rotatable about its base, as shown by an arrow, such that it could rotate 360 degrees. In other embodiments, the handle 110 may be optionally rotatable about a section a part-way up the length of the handle 110. By providing such rotatable options, the handle 110 may be convenient as the excess moisture drying apparatus 100 is being moved around the circular gasket of a washing machine in certain embodiments of the present invention.

The drying sponge 120 generally comprises a molded or manufactured form of a material having suitable liquid absorption properties for embodiments of the present invention. In many embodiments, the drying sponge 120 comprises a porous textile material capable of absorbing a large volume of water and similar liquids per cubic inch of the material. Suitable materials include any material having a water absorption property of at least 5.0%, defined as the relationship of the volume of the weight of the liquid absorbed to the weight of the dry material, per volume, expressed as a percentage in accordance with testing standard ATSM C20-00.

In some embodiments of the present invention, the drying sponge 120 comprises a highly absorbent material, such as a chamois cloth, woven cotton, or common sponge materials, for example, a combination of wood pulp, sodium sulphate crystals, hemp fibers and chemical softeners. In certain embodiments, the drying sponge 120 comprises a plurality of materials, for example, an inner core comprises a substantially rigid or formable material, such as one of the handle materials identified above, having a highly absorbent material, such as a chamois leather cloth or woven fabric cloth, surrounding a substantial portion of the outer surface of the inner core. Optionally, both an inner core and outer material are made from different, but absorbent materials. By providing such combinations of materials, the drying sponge 120 may be able to retain some resiliency through its inner core, yet have sufficient absorption properties in the outer material to render it suitable for embodiments of the present invention.

It should be appreciated by embodiments of the present invention, although disclosed as an inner core and outer material as if a single assembly, the outer material may be removable, such that a replacement cloth material may be changed. In such an embodiment, any type of known mechanical fastener (e.g., snaps, hooks, hook and loop fasteners, tie straps, elastic around a perimeter of the outer material, stitching/sewing the outer material into the inner core, etc.) may be utilized to keep the outer material removably affixed to the inner core during operation.

Generally, the drying sponge 120 may be formed into a specific shape to render it more suitable for a particular application. As shown in the Figure, in one exemplary embodiment, the drying sponge 120 may comprise a substantially I-beam shape such that it may reach into the difficult to access areas of a gasket for a front loading washing machine. In such an exemplary embodiment, the drying sponge 120 may be formed by having an inner core made from a polymer or rubber material, and an outer material comprising a highly absorbent cloth, such as a chamois cloth or woven fabric cloth. In such an embodiment, the length, width and height of the drying sponge 120 may be dependent upon the intended application for a particular style/size of washing machine. Alternative embodiments, depicting alternative shapes and sizes of drying sponges 120 are disclosed hereinbelow.

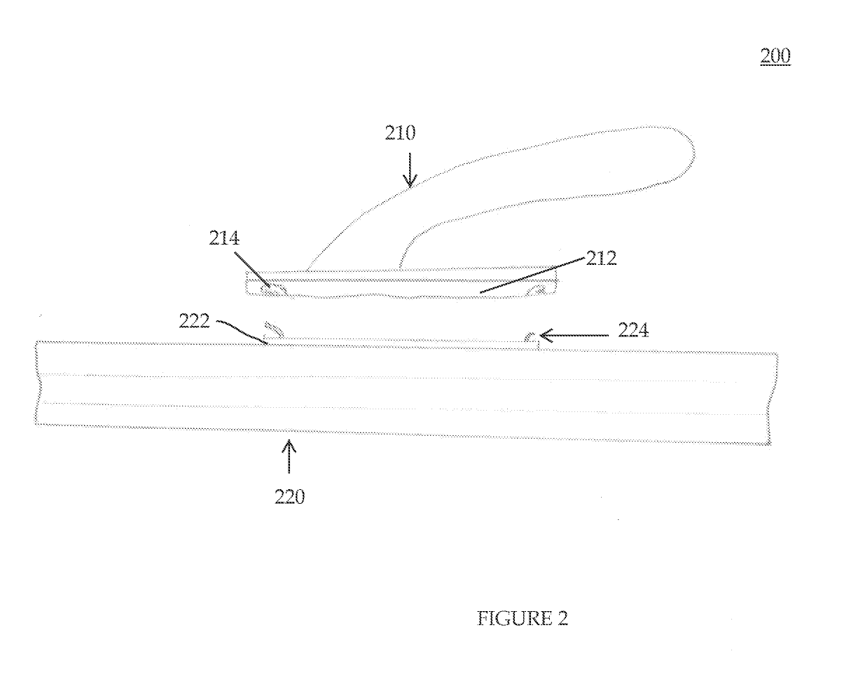

FIG. 2 depicts a side view of an excess moisture drying apparatus 200 in accordance with another embodiment of the present invention. In many embodiments, the handle 210 and drying sponge 220 are separable, such that the handle 210 may be detached and removed from the drying sponge 220 to replace the drying sponge 220, allow it to dry, etc. In such an embodiment, the handle 210 may comprise an attachment means 212 having one or more attachment components 214 for receiving the drying sponge 220. Similarly, in the same embodiment, the drying sponge 220 may comprise an attachment means 222 having one or more attachment components 224 for mating with the handle 210.

As shown in the Figure, in one exemplary embodiment, the attachment means 212 and 222 may comprise a clip-type assembly, having at least one protrusion 224 extending from the drying sponge 220 for being received by a recessed portion 214 on the handle 210. Alternative attachment means 212 and 214 may comprise hook and loop fasteners, mechanical snaps, removable adhesives, or similarly known mechanical or chemical means for attaching two mechanical devices together to render them suitable for intended embodiments of the present invention.

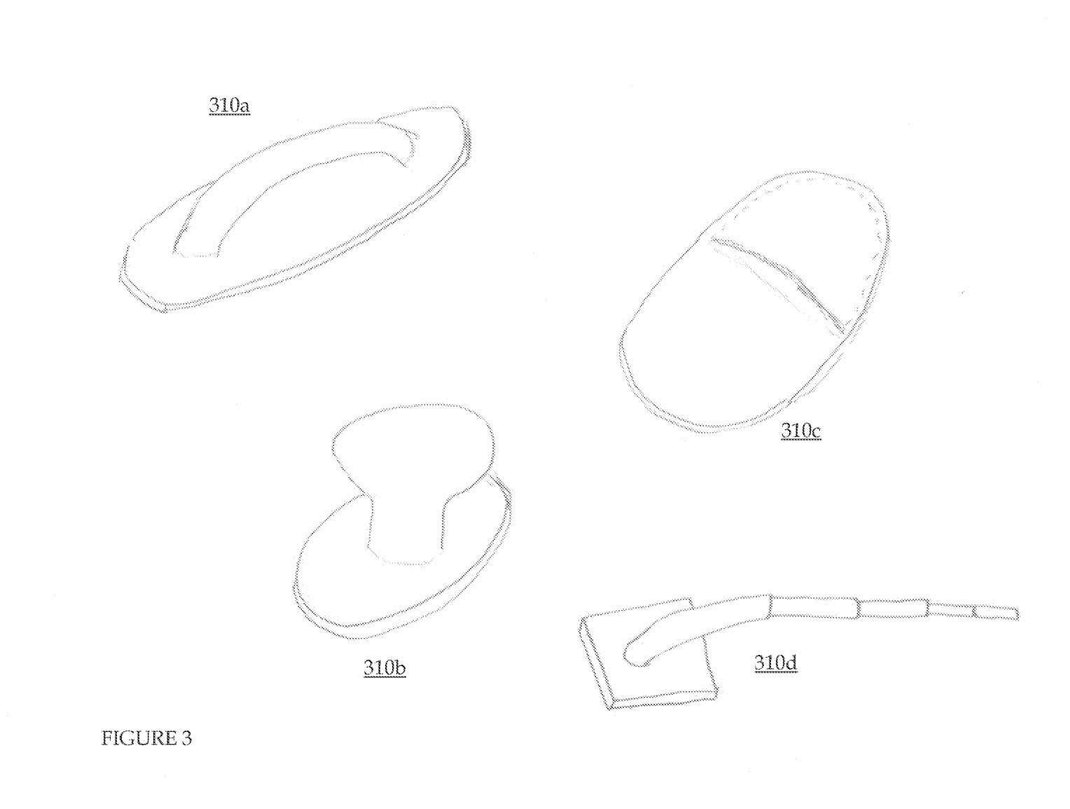

FIG. 3 depicts a plurality of alternative handles in accordance with further embodiments of the present invention. As shown in the Figure, various embodiments of the present invention support numerous types of handles, as exemplified in the few embodiments shown. For example, in addition to the handle 110 shown in FIG. 1, handle 310a is shown as comprising a protruded handle, connected on both ends, commonly found on briefcases, kitchen cabinets, etc. Exemplary handle 310b is shown as comprising a knob-type protrusion, which may be substantially circular or oval at its widest cross-section, similar to a door knob.

Exemplary handle 310c is shown as comprising a pocket style handle, which may optionally be lined with a soft fabric material (e.g., synthetic fur), for the comfort of a user's hand. Lastly, exemplary handle 310d is shown as comprising a telescopic type rod, rotatably fixed to a base portion, such that a user may be able to easily store the device when not in use. As shown in each of the exemplary handles 310a-d, the described feature of the handle is generally formed in connection with a base portion which is what may support the attachment means 212 described above with respect to FIG. 2.

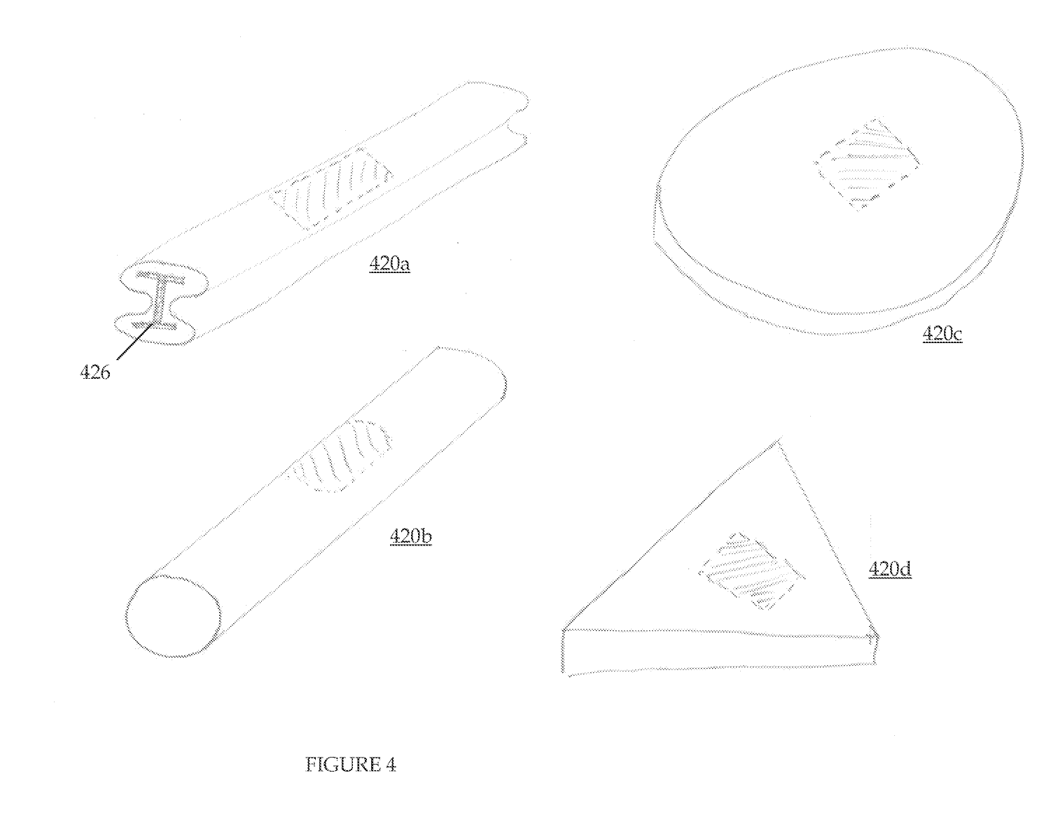

FIG. 4 depicts a plurality of alternative drying sponges in accordance with further embodiments of the present invention. Similar to the exemplary alternative handles shown in FIG. 3, embodiments of the present invention support numerous sizes and shapes of drying sponges, as shown in the exemplary embodiments in FIG. 4. For example, drying sponge 420a is shown as comprising a substantially I-beam shape, optionally having a substantially rigid inner core material 426 therein for maintaining the shape when in use. As described above, in such an embodiment, the drying sponge 420a may generally comprise an outer material, such as a chamois cloth or woven fabric cloth, removably affixed to the outer surface of the inner core material 426, for its drying properties.

Exemplary drying sponge 420b is shown as comprising a substantially cylindrical shape. Such an embodiment may be useful where a gasket or similarly recessed space is substantially cylindrical or may be temporarily deformed to be cylindrical (e.g., where a gasket is made of a soft rubber material, pushing a cylindrical object into the gasket would force it to temporarily deform into such shape.) Exemplary drying sponge 420c is shown as comprising a substantially round or oval cross section, having a height associated therewith, which may be used for any type of surface. Exemplary drying sponge 420d is shown as comprising a substantially triangular cross section having a height associated therewith. Such an embodiment may be suitable for reaching into a corner, for example, the corner of a bathroom adjacent or near a shower where moisture is likely to accumulate. Further to drying sponges 420c and 420d, any type of basic shape cross section (e.g., square, rectangle, polygons, etc.) may be utilized in accordance with embodiments of the present invention.

Each of the exemplary drying sponges 420a-d are shown as having a greyed out area on a top surface thereof. Such location may optionally comprise the location for the attachment means as described hereinabove. Although shown on the top surface of each of the exemplary drying sponges 420a-d, the attachment means may be positioned on any of the sides of the exemplary drying sponges 420a-d as well, depending on the intended use of the particular embodiment.

While the foregoing is directed to embodiments of the present invention, other and further embodiments of the invention may be devised without departing from the basic scope thereof. Furthermore, whereas the multitude of embodiments disclosed herein each provides a variety of elements within each embodiment, it should be appreciated any combination of elements from any combination of embodiments is well within the scope of further embodiments of the present invention.

What is claimed is:

1. An excess moisture drying apparatus comprising:
a handle portion; and
a drying portion affixed to the handle portion via an attachment means;
wherein the drying portion is sized to form fit within a water-sealing gasket of a front loading washing machine.

2. The excess moisture drying apparatus of claim 1, wherein the handle portion comprises a base portion and a protruding handle extending therefrom.

3. The excess moisture drying apparatus of claim 2, wherein the handle portion is rotatable about a base, and may rotate up to about 360 degrees.

4. The excess moisture drying apparatus of claim 1, wherein the handle comprises one of polyethylene terephthalate (PET), polyethylene (PE), high-density polyethylene, polyvinyl chloride (PVC), polyvinylidene chloride (PVDC) low-density polyethylene (LDPE), polypropylene (PP), Polystyrene (PS), high impact polystyrene (HIPS), polyamides (PA), acrylonitrile butadiene styrene (ABS), polycarbonate (PC), polycarbonate/acrylonitrile butadiene styrene (PC/ABS), polyurethanes (PU), or combinations thereof.

5. The excess moisture drying apparatus of claim 1, wherein the handle comprises one of a coated wood material, a metal or rubber.

6. The excess moisture drying apparatus of claim 1, wherein the drying portion comprises a water absorption property of at least 5.0%, defined as the volume of the weight of the liquid absorbed to the weight of the dry material, per volume.

7. The excess moisture drying apparatus of claim 1, wherein the drying portion comprises one of a chamois cloth or a woven cotton material

8. The excess moisture drying apparatus of claim 1, wherein the drying portion comprises a combination of wood pulp, sodium sulphate crystals, hemp fibers and chemical softeners.

9. The excess moisture drying apparatus of claim 1, wherein the drying portion comprises an inner core having a substantially rigid or formable material, and an outer core comprising a chamois cloth or a woven fabric cloth.

10. The excess moisture drying apparatus of claim 9, wherein the outer core material may be removable.

11. The excess moisture drying apparatus of claim 1, wherein the handle portion comprises one of a protrusion-type handle, being connected on a first end and a second end to the drying portion, a knob-type handle, a pocket style handle or a telescopic rod handle.

12. The excess moisture drying apparatus of claim 1, wherein the drying portion comprises one of a I-beam shaped sponge, a cylindrical sponge, a round sponge, an oval sponge or a triangular sponge.

13. An excess moisture drying apparatus comprising:
a handle portion having a base and a protruding handle extending therefrom; and
a sponge affixed to the handle portion via an attachment means, the sponge having an inner core having a substantially rigid or formable material, and an outer core comprising a chamois cloth or a woven fabric cloth, and the sponge having a gross water absorption property of at least 5.0%, defined as the volume of the weight of the liquid absorbed to the weight of the dry material, per volume;
wherein the drying portion is sized to form fit within a water-sealing gasket of a front loading washing machine.

14. The excess moisture drying apparatus of claim 13, wherein the handle comprises one of a coated wood material, a metal or rubber.

15. The excess moisture drying apparatus of claim 13, wherein the handle comprises one of polyethylene terephthalate (PET), polyethylene (PE), high-density polyethylene, polyvinyl chloride (PVC), polyvinylidene chloride (PVDC) low-density polyethylene (LDPE), polypropylene (PP), Polystyrene (PS), high impact polystyrene (HIPS), polyamides (PA), acrylonitrile butadiene styrene (ABS), polycarbonate (PC), polycarbonate/acrylonitrile butadiene styrene (PC/ABS), polyurethanes (PU), or combinations thereof.

16. The excess moisture drying apparatus of claim 13, wherein the handle is rotatable about a base, and may rotate up to about 360 degrees.

17. The excess moisture drying apparatus of claim 13, wherein the outer core material may be removable.

18. The excess moisture drying apparatus of claim 13, wherein the handle portion comprises one of a protrusion-type handle, being connected on a first end and a second end to the drying portion, a knob-type handle, a pocket style handle or a telescopic rod handle.

19. The excess moisture drying apparatus of claim 13, wherein the sponge comprises one of a I-beam shaped sponge, a cylindrical sponge, a round sponge, an oval sponge or a triangular sponge.

20. A method of drying a water-sealing gasket of a front loading washing machine comprising:
providing a drying apparatus comprising:
a handle portion having a base and a protruding handle extending therefrom; and
a sponge affixed to the handle portion via an attachment means, the sponge having an inner core having a substantially rigid or formable material, and an outer core comprising a chamois cloth or a woven fabric cloth, and the sponge having a gross water absorption property of at least 5.0%, defined as the volume of the weight of the liquid absorbed to the weight of the dry material, per volume;
wherein the drying portion is sized to form fit within the water-sealing gasket of a front loading washing machine;
placing the drying apparatus within the gasket; and
wiping the entire length of the gasket with the drying apparatus.
